(19) United States
(12) Patent Application Publication
(10) Pub. No.: US 2022/0236460 A1
(43) Pub. Date: Jul. 28, 2022

(54) DIAPHRAGM STRUCTURE

(71) Applicant: Merry Electronics(Shenzhen) Co., Ltd., Shenzhen (CN)

(72) Inventor: Tsai Ti Lai, Taichung (TW)

(73) Assignee: Merry Electronics(Shenzhen) Co., Ltd., ShenZhen (CN)

(21) Appl. No.: 17/358,014

(22) Filed: Jun. 25, 2021

(30) Foreign Application Priority Data
Jan. 22, 2021 (TW) 110102440

(51) Int. Cl. G02B 5/00

(52) U.S. Cl. CPC G02B 5/005

(57) ABSTRACT

A diaphragm structure including a suspension side edge and a central part is provided. The suspension side edge is connected to a periphery of the central part and surrounds the central part. The central part includes a main body part and a structural strengthening part, and the structural strengthening part is formed at a top end of the main body part.

### CROSS-REFERENCE TO RELATED APPLICATION

This application claims the priority benefit of Taiwan application serial no. 110102440, filed on Jan. 22, 2021. The entirety of the above-mentioned patent application is hereby incorporated by reference herein and made a part of this specification.

### BACKGROUND

### 1. Technical Field

The disclosure relates to a diaphragm structure, and particularly to a diaphragm structure including a suspension side edge and a central part.

### 2. Description of Related Art

Speakers generally include a diaphragm, which is driven by the interaction of the magnetic field generated by the current coil and the magnet, which squeezes the air and converts the mechanical vibration into sound. The material, vibration location and geometric shape of the diaphragm have an effect on the frequency response of the sound in different frequency bands. However, nowadays, most diaphragms are made of a single material, which makes it difficult to meet the different rigidity requirements of each part of the diaphragm at the same time. For example, the central part of the diaphragm, or dome, is prone to distortion due to insufficient rigidity, resulting in uneven vibration, and thus the sound performance of the corresponding frequency band is affected.

### SUMMARY

The disclosure provides a diaphragm structure, the central part of which has better structural rigidity.

A diaphragm structure of the disclosure includes a suspension side edge and a central part. The suspension side edge is connected to a periphery of the central part and surrounds the central part. The central part includes a main body part and a structural strengthening part, and the structural strengthening part is formed at a top end of the main body part.

In an embodiment of the disclosure, the main body part includes a first section and a second section. The second section is connected between the first section and the structural strengthening part, a surface of the central part in the first section is a convex arc surface, the surface in the second section is a concave arc surface, and the surface in the structure strengthening part is a convex arc surface.

In an embodiment of the disclosure, an amplitude turning point of the central part is located in the first section.

In an embodiment of the disclosure, a distance from a bottom end of the main body part of the central part to a top end of the structural strengthening part is larger than a distance from a bottom end of the suspension side edge to a top end of the suspension side edge.

In an embodiment of the disclosure, a central axis of the diaphragm passes through the structural strengthening part, and the structural strengthening part and the main body part are axisymmetric to the central axis.

In an embodiment of the disclosure, a material of the central part is different from a material of the suspension side edge.

In an embodiment of the disclosure, a rigidity of the central part is greater than a rigidity of the suspension side edge.

Based on the above, in the diaphragm structure of the disclosure, a structural strengthening part is formed at the top end of the central part, thereby increasing the structural rigidity of the central part. Accordingly, compared with conventional diaphragms, unexpected distortion during vibration is less likely to occur to the central part of the diaphragm structure of the disclosure, which can make the frequency response curve flatter and reduce the generation of troughs, thereby improving the sound output quality.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional view of a diaphragm structure according to an embodiment of the disclosure.

FIG. 2 is a cross-sectional view of a diaphragm structure of FIG. 1 along line I-I.

FIG. 3 is a partial enlarged view of a diaphragm structure of FIG. 2.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

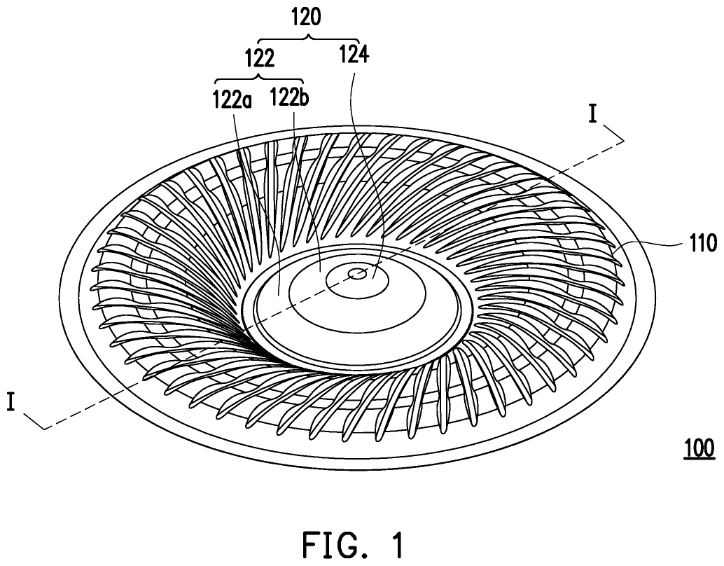

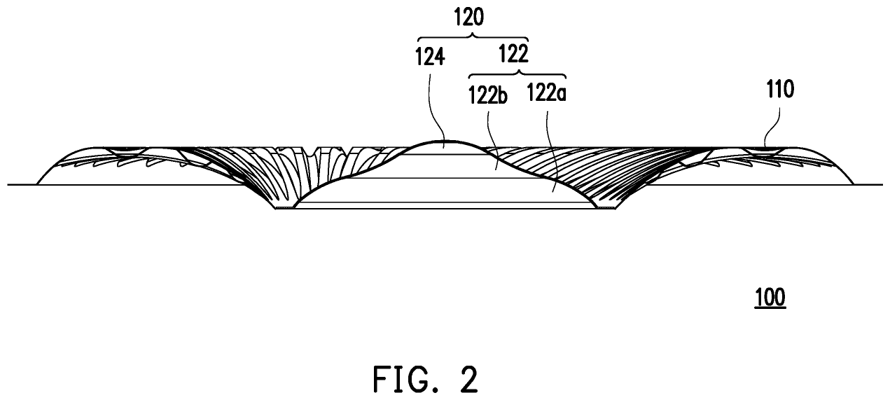

FIG. 1 is a three-dimensional view of a diaphragm structure according to an embodiment of the disclosure. FIG. 2 is a cross-sectional view of a diaphragm structure of FIG. 1 along line I-I. Referring to FIG. 1 and FIG. 2, a diaphragm structure 100 of the present embodiment includes a suspension side edge 110 and a central part 120. The suspension side edge 110 is connected to a periphery of the central part 120 and surrounds the central part 120. The central part 120 includes a main body part 122 and a structural strengthening part 124. The structural strengthening part 124 is formed at a top end of the main body part 122 so as to increase a structural rigidity of the central part 120. Accordingly, compared with conventional diaphragms, unexpected distortion during vibration is less likely to occur to the central part 120 of the diaphragm structure 100 of the present embodiment, which can make the frequency response curve flatter and reduce the generation of troughs, thereby improving the sound output quality.

Further, in the present embodiment, a material of the central part 120 is different from a material of the suspension side edge 110, for example. For example, the material of the central part 120 may be paper or other materials with higher rigidity, and the material of the suspension side edge 110 may be plastic or other materials with lower rigidity, such that the central part 120 has relatively large structural rigidity. In other embodiments, the central part 120 and the suspension side edge 110 may be made of other suitable materials, and the disclosure is not limited thereto.

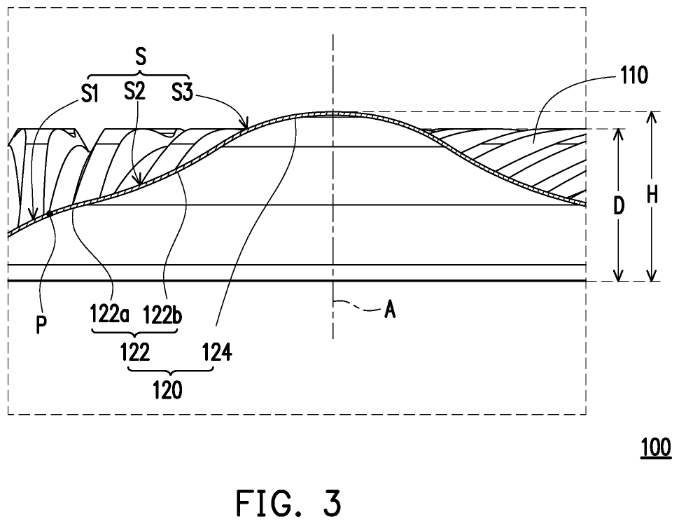

FIG. 3 is a partial enlarged view of a diaphragm structure of FIG. 2. Please refer to FIG. 3. In the present embodiment, a surface S of the central part 120 has different curved surface properties in different sections thereof, such that the structural strengthening part 124 is formed on a top end of the central part 120.

Specifically, the main body part 122 of the central part 120 includes a first section 122a and a second section 122b, where the second section 122b is connected between the first section 122a and the structural strengthening part 124. The surface S of the central part 120 in the first section 122a is a convex arc surface 51, the surface S of the central part 120 in the second section 122b is a concave arc surface S2, and the surface S of the central part 120 in the structural strengthening part 124 is a convex arc surface S3. In other words, a middle section (i.e. the second section 122b) of the central part 120 between a top section (i.e., the section where the structural strengthening part 124 is located) and an outer section (i.e. the first section 122a) is designed in a concave shape, so as to define the structural strengthening part 124 at the top end of the central part 120.

Further, because the central part 120 increases the overall structural rigidity through the structural strengthening part 124, when the central part 120 vibrates and becomes deformed, an amplitude turning point P will be farther away from the section where the structural strengthening part 124 is located and located in the outer section of the main body part 122 (i.e. the first section 122a), so as to reduce a degree of irregular distortion when the central part 120 vibrates.

Referring to FIG. 3, in the present embodiment, a central axis A of the diaphragm structure 100 passes through the structural strengthening part 124, and the structural strengthening part 124 and the main body part 122 are axisymmetric to the central axis A. That is, the diaphragm structure 100 is an axisymmetric structure, and the structural strengthening part 124 is formed at a geometric center of the diaphragm structure 100. Moreover, as shown in FIG. 3, a distance H from a bottom end of the main body part 122 of the central part 120 to a top end of the structural strengthening part 124 is larger than a distance D from a bottom end of the suspension side edge 110 to a top end of the suspension side edge 110.

In summary, in the diaphragm structure of the disclosure, a structural strengthening part is formed at the top end of the central part, thereby increasing the structural rigidity of the central part. Accordingly, compared with conventional diaphragms, unexpected distortion during vibration is less likely to occur to the central part of the diaphragm structure of the disclosure, which can make the frequency response curve flatter and reduce the generation of troughs, thereby improving the sound output quality.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A diaphragm structure, comprising:
a suspension side edge; and
a central part, the suspension side edge connected to a periphery of the central part and surrounding the central part, wherein the central part comprises a main body part and a structural strengthening part, and the structural strengthening part is formed at a top end of the main body part.

2. The diaphragm structure as described in claim 1, wherein the main body part comprises a first section and a second section, the second section is connected between the first section and the structural strengthening part, a surface of the central part in the first section is a convex arc surface, the surface in the second section is a concave arc surface, and the surface in the structure strengthening part is a convex arc surface.

3. The diaphragm structure as described in claim 2, wherein an amplitude turning point of the central part is located in the first section.

4. The diaphragm structure as described in claim 1, wherein a distance from a bottom end of the main body part of the central part to a top end of the structural strengthening part is larger than a distance from a bottom end of the suspension side edge to a top end of the suspension side edge.

5. The diaphragm structure as described in claim 1, wherein a central axis of the diaphragm passes through the structural strengthening part, and the structural strengthening part and the main body part are axisymmetric to the central axis.

6. The diaphragm structure as described in claim 1, wherein a material of the central part is different from a material of the suspension side edge.

7. The diaphragm structure as described in claim 1, wherein a rigidity of the central part is greater than a rigidity of the suspension side edge.
